(19) United States
(12) Patent Application Publication
(10) Pub. No.: US 2006/0167747 A1
(43) Pub. Date: Jul. 27, 2006

(54) Content-targeted advertising for interactive computer-based applications

(75) Inventors: Joshua T. Goodman, Redmond, WA (US); Christopher A. Meek, Kirkland, WA (US); Carl M. Kadie, Bellevue, WA (US)

Correspondence Address: AMIN & TUROCY, LLP, 24TH FLOOR, NATIONAL CITY CENTER, 1900 EAST NINTH STREET, CLEVELAND, OH, 44114, US

(73) Assignee: Microsoft Corporation, Redmond, WA (US)

(21) Appl. No.: 11/042,246

(22) Filed: Jan. 25, 2005

(51) Int. Cl. G06Q 30/00

(52) U.S. Cl. 705/14

(57) ABSTRACT

The subject invention provides a unique system and method that facilitates providing content-targeted advertising to a user based at least in part on the content of a user action. The user action can be performed in connection with an outbound messaging system, a real-time messaging system such as a chat or instant messaging, a game environment, and/or calendaring system. The system and method analyze at the least the content of an outbound message and then present a content-targeted advertisement based on the content of the message. The same can be done with respect to calendar entries. However, outbound and inbound calendar entries, invitations, and responses to invitations can be analyzed for content and have content-targeted advertisements presented to the sender or receiver of such items. User privacy can be maintained and/or increased by allowing a user to opt out of content-targeting advertisements. Reasons for being targeted can also be provided to the user.

### TECHNICAL FIELD

The subject invention relates generally to online advertising and in particular to the delivery of advertisements, the content of which is determined at least in part by the content associated with a user's interaction with a computer-based application.

### BACKGROUND OF THE INVENTION

Advertising in general is a key revenue source in just about any commercial market. To reach as many consumers as possible, advertisements are typically presented via billboards, television, radio, and print media such as newspapers and magazines. However, with the advent and rise of the Internet, advertisers have found a new and perhaps less expensive medium for reaching vast numbers of potential customers across a large and diverse geographic span. Advertisements on the Internet can primarily be seen on web pages or web sites as well as in pop-up windows when a particular site is visited.

In addition to web sites on the Internet, businesses interested in generating revenues continue to look for other channels that may be suitable for advertisements. One current delivery mode, for example, involves attaching an advertisement to an incoming email for the recipient of the email to view. The subject matter of the advertisement may be selected according to the content of the incoming mail. Unfortunately, this raises many privacy concerns particularly for the mail recipient. This delivery mode can also be problematic for the advertiser since many emails can now be automatically filtered and never be read by the recipient. Thus, there is a potential for a loss in advertising revenues as well as a loss of potential customers.

### SUMMARY OF THE INVENTION

The following presents a simplified summary of the invention in order to provide a basic understanding of some aspects of the invention. This summary is not an extensive overview of the invention. It is not intended to identify key/critical elements of the invention or to delineate the scope of the invention. Its sole purpose is to present some concepts of the invention in a simplified form as a prelude to the more detailed description that is presented later.

The subject invention relates to a system and/or methodology that facilitate presenting content-targeted advertisements to users and in particular, to senders or originators of messages and calendar related items, as well as to game and real-time messaging participants. More specifically, a user's action (or user action) can be analyzed in part for its content. Following, at least one content-targeted advertisement can be delivered to the user during the performance of such action. The content of the advertisement can be based at least in part upon the content of the user's action.

According to one aspect of the invention, the user's action can be described as preparing or typing an outbound message or playing or obtaining a high score in a game environment. In either of these actions, content associated with the action can be analyzed. Thus, the content of the outbound message can be analyzed and an advertisement based in part on the content of such message can be delivered to the message sender. The advertisement can be presented while the action is being performed (e.g., as the user is inputting the message), at the sending of the message, or shortly after the message is sent. Likewise, the content of a current or recent game environment including a user's performance in the particular environment can be examined and one or more advertisements can be presented based thereon.

In a real-time messaging scenario, such as a chat or instant messaging conversation, the most current message entered and/or sent by the conversation's participants or a history of the parties' outgoing messages (e.g., last 10 messages, last 10 minutes of messages, etc.) can be analyzed as well for its content. Finally, the content of the user's calendar entries (e.g., appointments, meetings, events, birthdays, anniversaries, invitations, invitation responses, etc.) can be evaluated for their content in addition to the time, date, and/or day of the week of the respective entries. Since some calendar entries incorporate other parties, such as a meeting entry that requests or requires the presence of others, such other parties (or invitees) can also receive a content-targeted advertisement based at least on the content of the invitation. A content-targeted advertisement can also be sent to the invitee when a response (e.g., acceptance, rejection, tentative, etc.) to the invitation is sent.

According to another aspect of the invention, other types of information can be included in the content analysis either apart from or together with the content of the user action. For instance, the user's information (e.g., profile) can be employed in combination with the content of the user's action. In addition, the user's demographic or geographic information can be considered. The recipient's domain or username can also be included in the content analysis.

As a result of analyzing the content of an outbound message, calendar entry, and/or real-time outbound message, the system and/or method of the invention may determine that the content is not appropriate or does not warrant an advertisement. This can be particularly true when a topic of an outbound message or calendar entry denotes a negative subject matter such as death or some other failure (e.g., failed product, failed service, etc.).

Alternatively, user privacy can be increased by incurring some type of fee (e.g., monetary or non-monetary based fee). For example, the fee can be paid in exchange for not receiving advertisements at all or for not receiving content-targeted advertisements. The fees may differ between the two options. The latter option may result in a reduced user experience since non-content targeted advertisements may still be presented to the user but with a more flashy presentation.

For users who choose to continue to receive the content-targeted advertisements but would like to learn how or why they are targeted for any given advertisements, the user can be provided a brief explanation or overview. For example, the advertisement can include such information in its presentation or the user can hover over the advertisement to view the information. Another option allows the user to click on the advertisement to view the information before being directed to the actual advertisement.

According to yet another aspect of the invention, the system and method can facilitate selling content-targeted advertisements to advertisers through a bidding process or via negotiated prices. The bidding or negotiated prices can be based on pricing models including but not limited to cost per 1,000 (CPM), cost per click (CPC), cost per acquisition (CPA—e.g., purchase), cost-per-sale, and/or revenue-sharing.

To the accomplishment of the foregoing and related ends, certain illustrative aspects of the invention are described herein in connection with the following description and the annexed drawings. These aspects are indicative, however, of but a few of the various ways in which the principles of the invention may be employed and the subject invention is intended to include all such aspects and their equivalents. Other advantages and novel features of the invention may become apparent from the following detailed description of the invention when considered in conjunction with the drawings.

### BRIEF DESCRIPTION OF THE DRAWINGS

FIG. 1 is a high-level block diagram of a content-targeted advertisement system in accordance with an aspect of the subject invention.

FIG. 2 is a schematic diagram illustrating the types of outbound messages included in the term user action as employed in accordance with an aspect of the subject invention.

FIG. 3 is a schematic diagram depicting multiple parties sending outbound messages in a chat or instant messaging environment in accordance with an aspect of the subject invention.

FIG. 4 is a schematic diagram that demonstrates when content-targeted advertisements can be “triggered” when a user employs a calendaring application in accordance with an aspect of the subject invention.

FIG. 5 is a block diagram of a targeted advertisement system that can present either content-targeted or non-content targeted advertisements to a user according to the user's preferences in accordance with an aspect of the subject invention.

FIG. 6 is a flow chart illustrating an exemplary methodology that facilitates content-targeting advertising in accordance with an aspect of the subject invention.

FIG. 7 is a flow chart illustrating an exemplary methodology facilitates content-targeting advertising with respect to outbound messages in accordance with an aspect of the subject invention.

FIG. 8 is a flow chart illustrating an exemplary methodology facilitates content-targeting advertising with respect to real-time outbound messages in accordance with an aspect of the subject invention.

FIG. 9 is a flow chart illustrating an exemplary methodology facilitates content-targeting advertising with respect to a game environment in accordance with an aspect of the subject invention.

FIG. 10 is a flow chart illustrating an exemplary methodology facilitates maintaining and/or improving user privacy in connection with content-targeting advertising in accordance with an aspect of the subject invention.

FIG. 11 is a flow chart illustrating an exemplary methodology facilitates maintaining and/or improving user privacy in connection with content-targeting advertising in accordance with an aspect of the subject invention.

FIG. 12 illustrates an exemplary environment for implementing various aspects of the invention.

### DETAILED DESCRIPTION OF THE INVENTION

The subject invention is now described with reference to the drawings, wherein like reference numerals are used to refer to like elements throughout. In the following description, for purposes of explanation, numerous specific details are set forth in order to provide a thorough understanding of the subject invention. It may be evident, however, that the subject invention may be practiced without these specific details. In other instances, well-known structures and devices are shown in block diagram form in order to facilitate describing the subject invention.

As used in this application, the terms “component” and “system” are intended to refer to a computer-related entity, either hardware, a combination of hardware and software, software, or software in execution. For example, a component may be, but is not limited to being, a process running on a processor, a processor, an object, an executable, a thread of execution, a program, and a computer. By way of illustration, both an application running on a server and the server can be a component. One or more components may reside within a process and/or thread of execution and a component may be localized on one computer and/or distributed between two or more computers.

The subject invention can incorporate various inference schemes and/or techniques in connection with selecting and/or presenting content-targeted advertisements to users based on at least the content of their outbound message, calendar entry, or gaming mode and environment. As used herein, the term “inference” refers generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

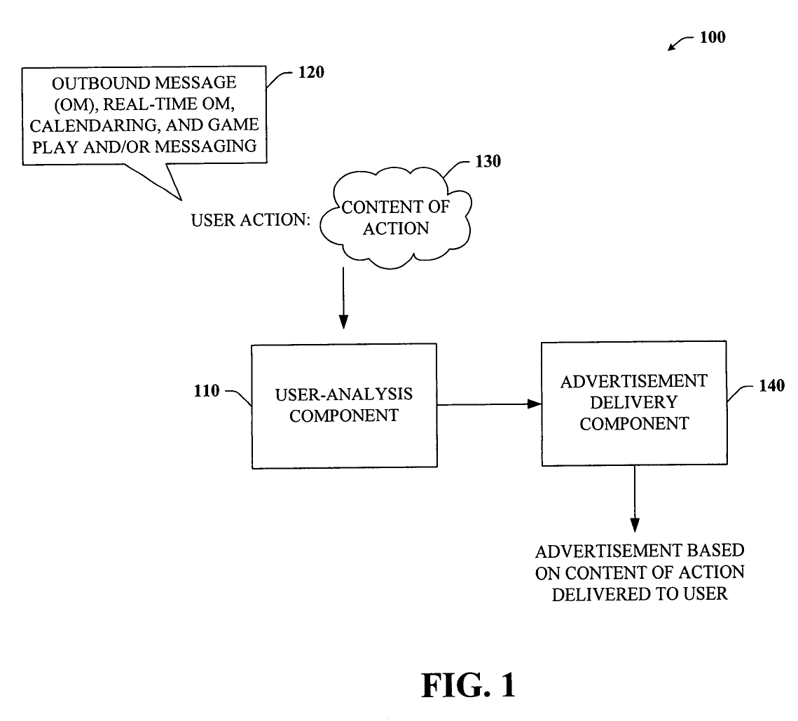

Referring now to FIG. 1, there is a general block diagram of a content-targeted advertising system 100 in accordance with an aspect of the subject invention. The system 100 includes a user-analysis component 110 that analyzes a user action 120 for its content 130. The user action 120 can be defined as creating or sending an outbound message, creating or sending an outbound message in a real-time messaging application, creating or sending a calendar entry, and/or game play or messaging in a gaming environment. The content of the user action can include any text or image in the outbound message. For example, a sender of an outbound message that includes an image attachment or an image embedded in the message may receive an advertisement for image sharing or image printing services. The advertisement can be appended to or otherwise inserted in the outbound message by an advertisement delivery component 140 and be viewable to the sender as well as the receiver of the message.

Alternatively, the advertisement can be presented to the sender via a pop-up window separate from the outbound message. In some instances, the user can select the manner in which such advertisements are presented or delivered.

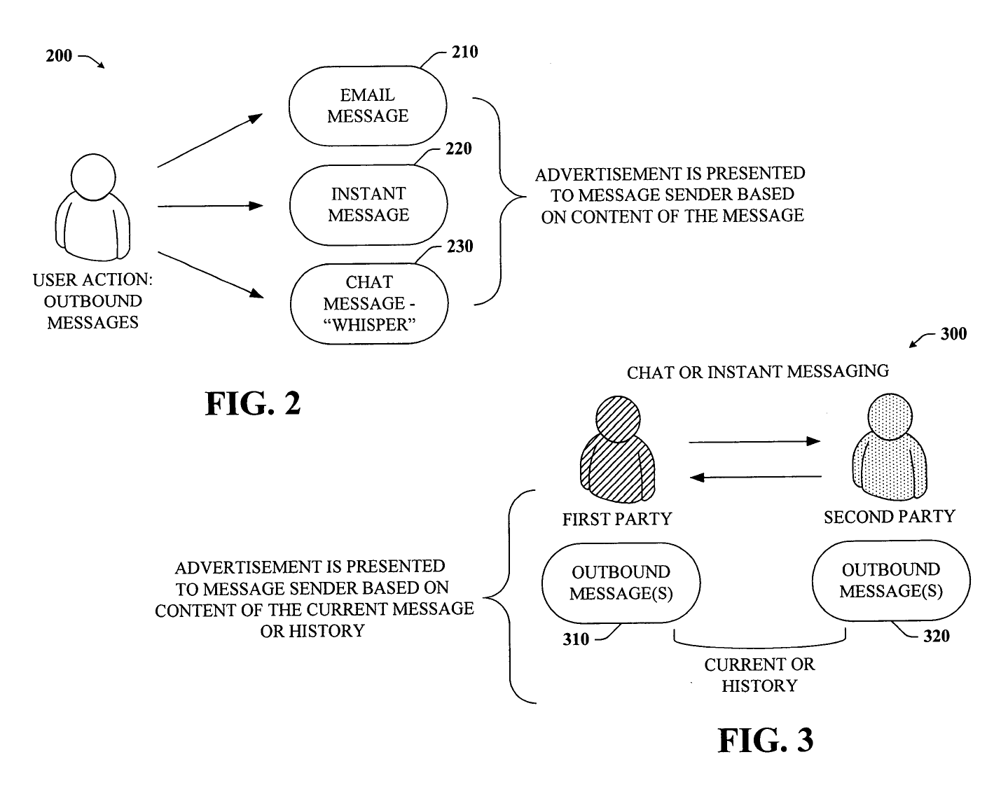

Referring now to FIG. 2, there is illustrated a schematic diagram that demonstrates exemplary forms 200 of outbound messages as contemplated according to an aspect of the subject invention. An outbound message can include outgoing electronic mail messages 210, outgoing instant messages 220 (real-time communication), and/or outgoing chat messages 230 such as when at least two users are in whisper mode and thus can communicate within a chat room but only to one another.

In addition to the content of any outbound message, the user (originator of the message) profile can be considered in the content analysis. For example, the user profile may include demographic or geographic information about the user such as an age range, occupation, time zone, or residence location. The recipient named in any outbound message can also be evaluated for its user name and/or domain along with the (body) content of such message. For instance, an ABC email system might append advertisements about ABC internet access when sending a message to a domain such as PQR that offers a competing service. Furthermore, the recipient's domain can be employed to infer their location. That is, for a recipient in an .UK domain, advertisements specific to the United Kingdom can be attached or presented accordingly to the recipient and/or sender.

Outbound instant messages can also encompass game messaging whereby a plurality of players communicate with each other via instant messaging (and/or chat conversations) within a computer-based game environment. The game environment and the user's particular state or place in the game can also provide content on which content-targeted advertisements can be based. For example, the type of game (e.g., action, strategy, educational, etc.) being played, the user's level of play (e.g., beginner's, advanced, etc.), the user's position in the game (e.g., individual or team play), and/or the sub-game being played can be considered to be part of the content analyzed to determine the most appropriate content-targeted advertisements to show.

In practice, for instance, advertisements for other games or game equipment can be presented to the player according to any of the named factors. If a user is at a beginner's level of play, then advertisements for simpler, less complex games may be shown. Furthermore, advertisements clicked on by teammates or by other players having a similar background (e.g., expertise level, game history, high scores, user profile, etc.) as the user can be presented to the user as well.

In the gaming environment, content-targeted advertisements can be presented in game lobbies as a user waits for the game to begin or to continue, on various screens throughout the game such as preview screens, menu screens, and/or a high score screen, and/or within the active screens of the game (e.g., product placement throughout the game).

Turning now to the schematic diagram 300 of FIG. 3, chat room or instant messaging conversations differ slightly from a characteristic outbound message because there are two sides or parties to the conversation: a first party 310 and a second party 320. In addition, chat conversations as well as instant message conversations tend to exist for an extended period of time. Thus, each party can be both sender and recipient to a stream of messages dealing with the same content or topic. For this reason, the most recent message typed and/or sent can be analyzed for its content. Additionally, a history of the conversation can be analyzed to determine which content-targeted advertisements are suitable. For example, some instances may warrant that the last 10 sentences and/or the last 10 minutes of messages should be considered and evaluated. In others, the content of the most recent sentence or message may be sufficient.

Some parties to a chat or instant messaging conversation may be presented with different content-targeted advertisements. Thus, to keep all of the parties within a chat room, for example, equally informed with respect to the products or services being advertised to only some of the parties therein, notifications can be made. For example, the first party 310 can be notified of the advertisements received or clicked on by the second party 320, and vice versa. This can encourage more clicks on the advertisements and more opportunity for the advertisers. Sharing of information between the parties can also be improved.

Additional information such as the name of the chat room as well as the subject matter or type of advertisements previously or recently clicked on by various parties (participants) in the chat room can be examined as well. For instance, chat rooms tend to be named such as “Singles over 30” or “Orchid Lovers”. Independent of any message content, advertisements targeted for dating services or orchid growers, respectively, can be presented to the parties.

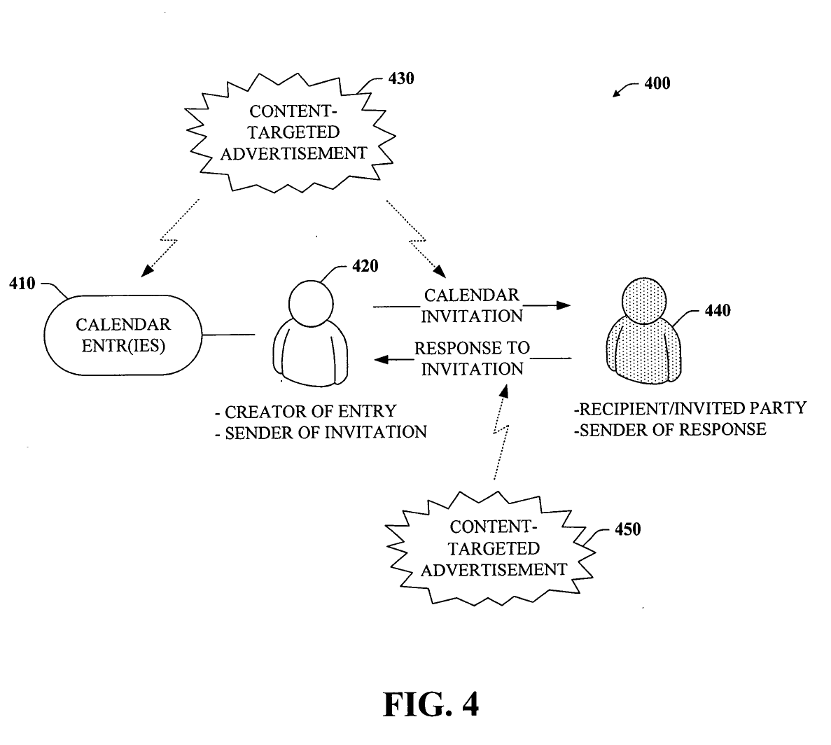

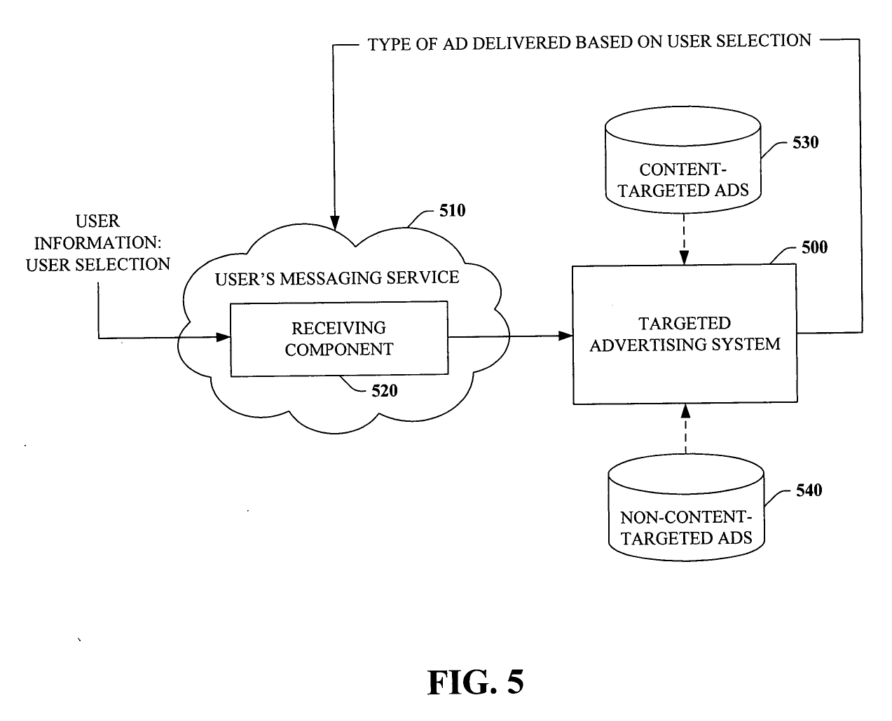

Referring now to FIG. 4, there is illustrated a schematic diagram 400 that demonstrates the delivery of content-targeted advertisements with respect to calendaring applications. In the diagram 400, the creation of a calendar entry 410 by a user 420 can trigger at least one content-targeted advertisement 430 to be presented. The content of the entry can be analyzed separately or in combination with the day of the week, time, and/or date associated with the entry. For example, an entry for a Saturday can cause different advertisements to appear than if the entry was slated for a weekday.

Calendar entries can be unique in that they can not only intimately involve the creator of the entry but they can also require the attendance or presence of other users. Take a meeting request or invitation for example. The user 420 can enter a meeting for a particular date and request or require another user 440 (invitee) to attend. A content-targeted advertisement can be presented to both the sender and recipient of the meeting invitation based on the meeting entry. Recipients of the meeting entry can receive any advertisements appended to the outbound message (meeting invitation) as well as additional content-targeted advertisements upon receipt. When the user 440 responds to the meeting request, additional content-targeted advertisements 450 can be triggered and presented to the user 440. Thus, content-targeted advertisements can be sent for outbound entries (creation of or requests) as well as inbound calendar entries.

Moving on, there is illustrated a block diagram of a targeted advertising system 500 that can deliver content-targeted or non-content targeted advertisements to any user depending on the user's preferences for a particular messaging service 510 that is employed by the user. As shown in the diagram, a user can enter his/her information upon set up of an account, for example, such as to initiate use of the messaging service 510. Examples of the messaging service 510 can include electronic mail systems, real-time communication systems, calendaring systems, and/or gaming systems. The user's information can be received by a receiving component 520 within or controlled by the messaging service 510.

The receiving component 520 can communicate at least a portion of the information to the advertising delivery system 500 as it relates to advertisement delivery preferences, for instance. The advertising delivery system 500 can access and retrieve advertisements from a content-targeted ad data store 530 or a non-content targeted ad data store 540—depending on the user's selection or preference. The appropriate advertisements can then be communicated to the user via the user's messaging service 510.

Recall that in order to select a content-targeted advertisement, the user's action (e.g., outgoing message, calendar entry, etc.) is analyzed in some way to extract the content of the action. Thus, privacy of the user can be increased by selecting to receive non-content targeted advertisements. This is because the user's outbound messages, for example, can no longer be scanned and analyzed for their content. Instead, targeted advertisements can be delivered to the user and a monetary or non-monetary fee may be incurred by the user. For example, the user's message storage limit may be reduced, message length quotas may be lowered, and/or a fee may be charged to the user. The non-content targeted advertisements may also appear to be more flashy and distracting to the user. Hence, an overall reduced user experience can result from selecting to receive non-content targeted advertisements.

In the interest of preserving user privacy and maintaining a positive user experience, another option is available to the user. In particular, the user can be notified of the information that was used to target him. As a result, the user can avoid accidentally revealing sensitive information to third parties. For instance, the government could conceivably create an ad that said “Free lottery tickets” but target it based on words like “smoke marijuana” and then use the fact that someone had clicked on “Free lottery tickets” as evidence that they had received email about smoking marijuana. The user's privacy would have been violated in this instance. To avoid this, users can be informed as to what information they are revealing when they click on an advertisement. For instance, the advertisement can explicitly list the relevant information. Alternatively, hovering over the advertisement can provide this information. In addition, the user can click on the advertisement, be told what the targeting information was, and only then proceed to the advertisement.

Various methodologies in accordance with the subject invention will now be described via a series of acts, it is to be understood and appreciated that the subject invention is not limited by the order of acts, as some acts may, in accordance with the subject invention, occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the subject invention.

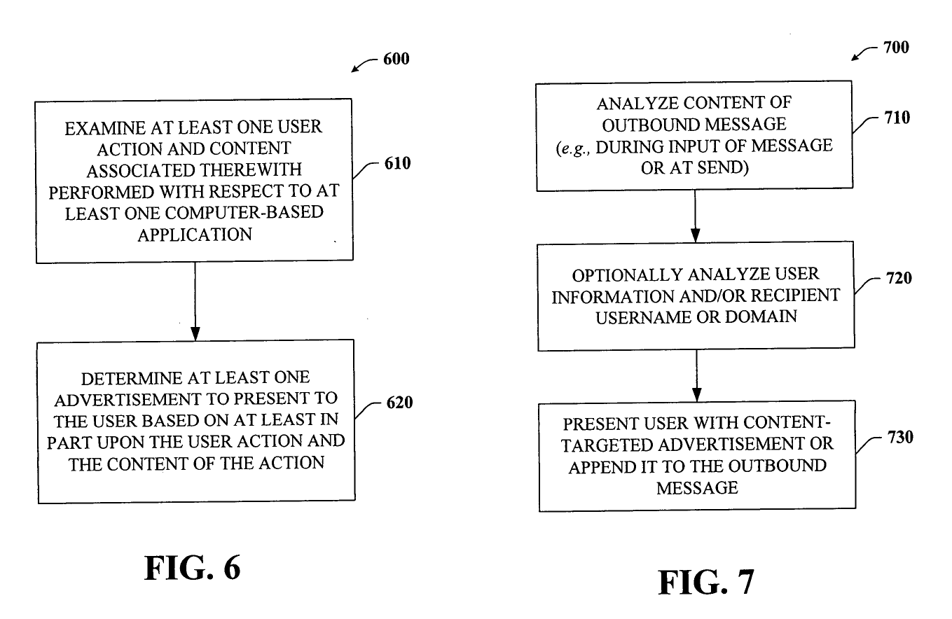

Referring now to FIG. 6, there is a flow diagram of an exemplary method 600 that facilitates providing content-targeted advertisements to users when utilizing computer-based interactive applications. The method 600 involves examining at least one user action and the content associated therewith at 610, whereby the user action is performed with respect to at least one computer-based application. The user action can be defined as any one of the following: preparing or sending an outbound message, preparing or sending a real-time (outbound) message, preparing or sending a calendar entry, receiving a calendar entry, responding to a calendar entry, and/or participating in a game system.

The content of the user action can be analyzed to determine and/or select at least one content-targeted advertisement to present (to the user) at 620. For example, imagine the user, described as a 60 year old man (from his user profile), is typing a message about collectible stuffed animals. According to the content of the message, the method 600 can select and present a content-targeted advertisement involving display cases for collectibles or about where to find or buy collectible stuffed animals.

Referring now to FIG. 7, there is shown a flow diagram of an exemplary method 700 that facilitates providing content-targeted advertisements based on the content of outbound messages. The method 700 involves analyzing the content of the outbound message at 710. Analysis can take place as the message is being entered by the user or upon the sending of the message.

Optionally at 720, the user's information (e.g., profile) and/or the recipient's username and/or domain can be analyzed together with the content of the message to further facilitate determining the appropriate content-targeted advertisements to deliver to the user (sender). At 730, the user can be presented with at least one content-targeted advertisement. Alternatively, the advertisement can be appended to the outbound message when it is sent and viewed by the sender and/or the receiver of the message.

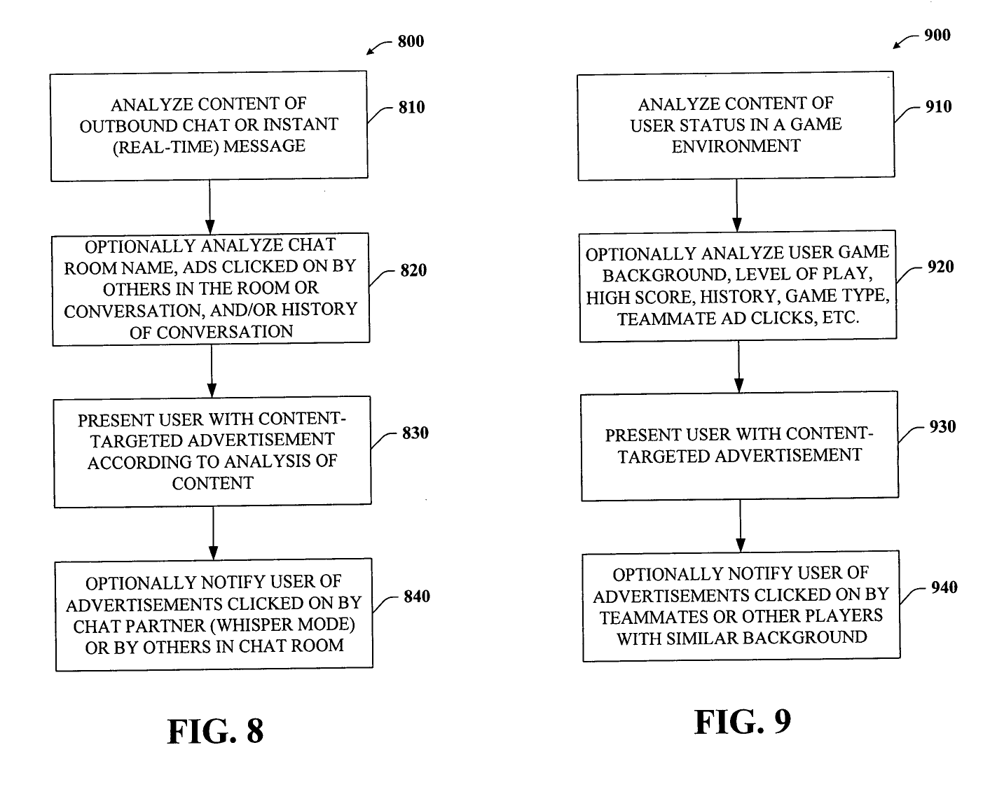

In FIG. 8, an exemplary method 800 demonstrates employing the method 600 with respect to chat or other real-time communication systems. The method 800 includes analyzing the content of the outbound chat or instant message at 810. Optionally at 820, the particular chat room name, advertisements clicked on by other participants in the room or conversation, and/or the history of the conversation (between at least 2 parties) can also be considered and factored into the content analysis.

At 830, the user (sender) can be shown at least one content-targeted advertisement—which has been chosen by the method 800 based at least on the content of the chat or instant message (real-time message). It should be appreciated that the real-time messaging take place in designated chat rooms or between at least any two parties carrying on an online conversation. However, the real-time messaging can also take place in gaming environments, whereby players (teammates or competitors) can communicate directly with one another via messaging during the game or at various points throughout the game.

At 840, one party or user can be notified of advertisements clicked or viewed by another party or user. For example, chat room participants typically share some characteristics, qualities, likes or dislikes with each other. Thus, when one participant clicks on an advertisement (e.g., a content-targeted advertisement), at least one other participant in the room may also like to know about the advertisement and can be notified of such advertisement and/or the fact that another participant in the chat room viewed it.

Referring now to FIG. 9, there is a flow diagram of an exemplary process 900 of providing content-targeted advertising to users in a game environment in accordance with an aspect of the subject invention. The process 900 involves analyzing content of a user's state or status in a game environment at 910. The user state can include the user's current position in the game or the current level of play reached in the game, or any messages sent by the user to other game players, for example. At 920, additional content regarding the user can be analyzed as well such as the user's level of expertise, high score history or position among high scorers, the type of game, and/or the types of other games recently purchased or played by the user.

At 930, the user can be presented with at least one content-targeted advertisement either on screen during play, wherein the advertisement is incorporated into the game scene, or outside of play such as on various menu and list screens (e.g., high score list, recent player list, etc.) displayed at the beginning or end of the game. The user can also be compared to other users who may exhibit a similar game background and as a result, be shown similar advertisements at 940.

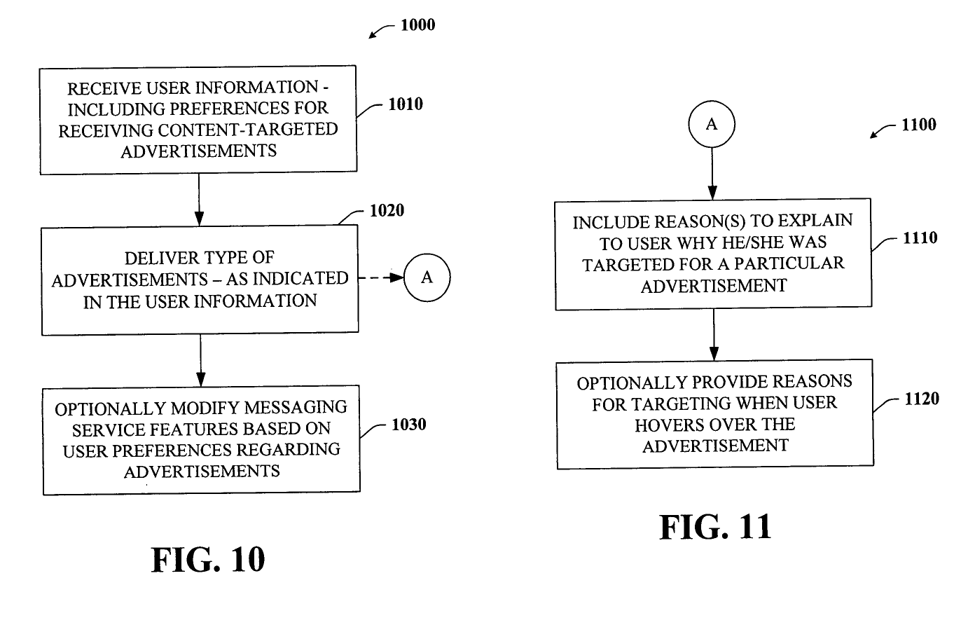

Turning now to FIG. 10, there is a flow diagram of an exemplary process 1000 that facilitates providing user options and allowing user privacy to be controlled by the user. The process 1000 includes receiving user information such as generic user information (e.g., demographic and/or geographic information) and user preferences when setting up a messaging service for use. User preferences can include a selection as to the type of targeted advertising to receive and/or a selection to be notified of the reason(s) targeted for any particular advertisement.

At 1020, the specified type of targeted advertisements is delivered to the user. Optionally at 1030, one or more messaging service options or features can be modified according to the user's selection of targeted advertising. For example, when a user selects against receiving content-targeted advertisements in order to maintain a higher level of privacy, targeted advertisements that are perhaps more flashy or obnoxious than their content-targeted counterparts can be delivered to the user. Alternatively or in addition, other features such as message quotas, message or attachment size maximums, or storage availability can be decreased or reduced.

On the contrary, users can still manage and stay in control of their privacy with content-targeted advertising by requesting notification of the reasons for being targeted for any advertisements. For instance, a notification method 1100 in FIG. 111 demonstrates that reasons can be included with or on the advertisement at 1110 to explain to the user why he/she was targeted for the particular advertisement. Thus, the user can be informed of the information or content used when determining to present the particular advertisement. At 1120, such reasons can be provided when the user hovers over the advertisement in addition to or instead of having them included on the advertisement. Moreover, the user is kept informed of what information about the user is employed to determine content-targeted advertisements.

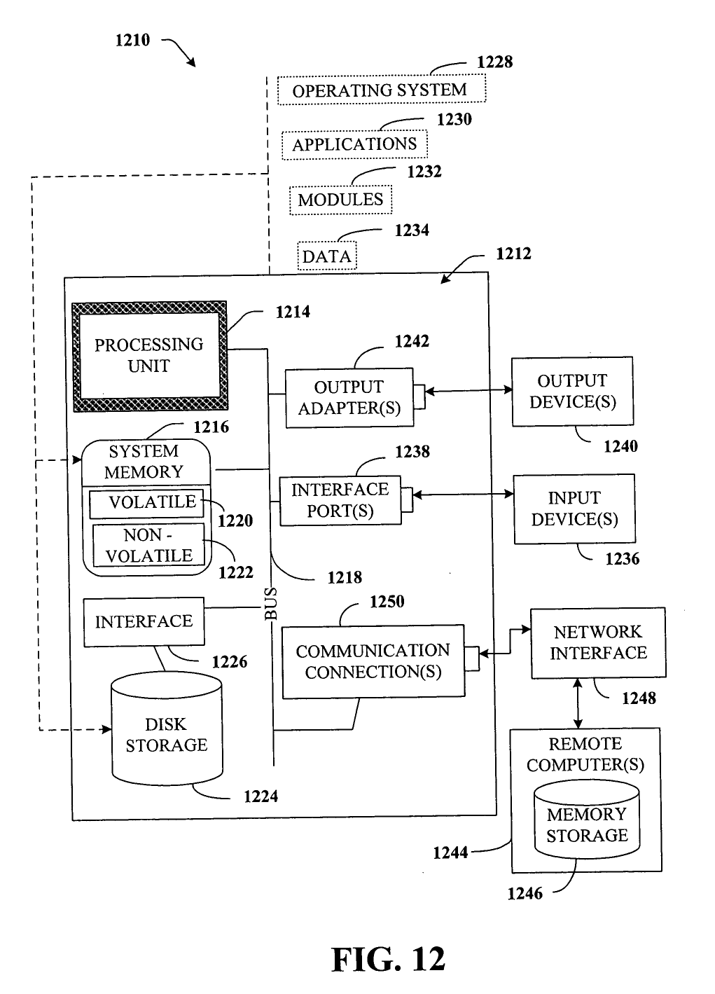

In order to provide additional context for various aspects of the subject invention, FIG. 12 and the following discussion are intended to provide a brief, general description of a suitable operating environment 1210 in which various aspects of the subject invention may be implemented. While the invention is described in the general context of computer-executable instructions, such as program modules, executed by one or more computers or other devices, those skilled in the art will recognize that the invention can also be implemented in combination with other program modules and/or as a combination of hardware and software.

Generally, however, program modules include routines, programs, objects, components, data structures, etc. that perform particular tasks or implement particular data types. The operating environment 1210 is only one example of a suitable operating environment and is not intended to suggest any limitation as to the scope of use or functionality of the invention. Other well known computer systems, environments, and/or configurations that may be suitable for use with the invention include but are not limited to, personal computers, hand-held or laptop devices, multiprocessor systems, microprocessor-based systems, programmable consumer electronics, network PCs, minicomputers, mainframe computers, distributed computing environments that include the above systems or devices, and the like.

With reference to FIG. 12, an exemplary environment 1210 for implementing various aspects of the invention includes a computer 1212. The computer 1212 includes a processing unit 1214, a system memory 1216, and a system bus 1218. The system bus 1218 couples system components including, but not limited to, the system memory 1216 to the processing unit 1214. The processing unit 1214 can be any of various available processors. Dual microprocessors and other multiprocessor architectures also can be employed as the processing unit 1214.

The system bus 1218 can be any of several types of bus structure(s) including the memory bus or memory controller, a peripheral bus or external bus, and/or a local bus using any variety of available bus architectures including, but not limited to, 11-bit bus, Industrial Standard Architecture (ISA), Micro-Channel Architecture (MCA), Extended ISA (EISA), Intelligent Drive Electronics (IDE), VESA Local Bus (VLB), Peripheral Component Interconnect (PCI), Universal Serial Bus (USB), Advanced Graphics Port (AGP), Personal Computer Memory Card International Association bus (PCMCIA), and Small Computer Systems Interface (SCSI).

The system memory 1216 includes volatile memory 1220 and nonvolatile memory 1222. The basic input/output system (BIOS), containing the basic routines to transfer information between elements within the computer 1212, such as during start-up, is stored in nonvolatile memory 1222. By way of illustration, and not limitation, nonvolatile memory 1222 can include read only memory (ROM), programmable ROM (PROM), electrically programmable ROM (EPROM), electrically erasable ROM (EEPROM), or flash memory. Volatile memory 1220 includes random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM).

Computer 1212 also includes removable/nonremovable, volatile/nonvolatile computer storage media. FIG. 12 illustrates, for example a disk storage 1224. Disk storage 1224 includes, but is not limited to, devices like a magnetic disk drive, floppy disk drive, tape drive, Jaz drive, Zip drive, LS-100 drive, flash memory card, or memory stick. In addition, disk storage 1224 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1224 to the system bus 1218, a removable or non-removable interface is typically used such as interface 1226.

It is to be appreciated that FIG. 12 describes software that acts as an intermediary between users and the basic computer resources described in suitable operating environment 1210. Such software includes an operating system 1228. Operating system 1228, which can be stored on disk storage 1224, acts to control and allocate resources of the computer system 1212. System applications 1230 take advantage of the management of resources by operating system 1228 through program modules 1232 and program data 1234 stored either in system memory 1216 or on disk storage 1224. It is to be appreciated that the subject invention can be implemented with various operating systems or combinations of operating systems.

A user enters commands or information into the computer 1212 through input device(s) 1236. Input devices 1236 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 1214 through the system bus 1218 via interface port(s) 1238. Interface port(s) 1238 include, for example, a serial port, a parallel port, a game port, and a universal serial bus (USB). Output device(s) 1240 use some of the same type of ports as input device(s) 1236. Thus, for example, a USB port may be used to provide input to computer 1212, and to output information from computer 1212 to an output device 1240. Output adapter 1242 is provided to illustrate that there are some output devices 1240 like monitors, speakers, and printers among other output devices 1240 that require special adapters. The output adapters 1242 include, by way of illustration and not limitation, video and sound cards that provide a means of connection between the output device 1240 and the system bus 1218. It should be noted that other devices and/or systems of devices provide both input and output capabilities such as remote computer(s) 1244.

Computer 1212 can operate in a networked environment using logical connections to one or more remote computers, such as remote computer(s) 1244. The remote computer(s) 1244 can be a personal computer, a server, a router, a network PC, a workstation, a microprocessor based appliance, a peer device or other common network node and the like, and typically includes many or all of the elements described relative to computer 1212. For purposes of brevity, only a memory storage device 1246 is illustrated with remote computer(s) 1244. Remote computer(s) 1244 is logically connected to computer 1212 through a network interface 1248 and then physically connected via communication connection 1250. Network interface 1248 encompasses communication networks such as local-area networks (LAN) and wide-area networks (WAN). LAN technologies include Fiber Distributed Data Interface (FDDI), Copper Distributed Data Interface (CDDI), Ethernet/IEEE 1102.3, Token Ring/IEEE 1102.5 and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 1250 refers to the hardware/software employed to connect the network interface 1248 to the bus 1218. While communication connection 1250 is shown for illustrative clarity inside computer 1212, it can also be external to computer 1212. The hardware/software necessary for connection to the network interface 1248 includes, for exemplary purposes only, internal and external technologies such as, modems including regular telephone grade modems, cable modems and DSL modems, ISDN adapters, and Ethernet cards.

What has been described above includes examples of the subject invention. It is, of course, not possible to describe every conceivable combination of components or methodologies for purposes of describing the subject invention, but one of ordinary skill in the art may recognize that many further combinations and permutations of the subject invention are possible. Accordingly, the subject invention is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system that facilitates targeting advertising on an interactive computer-based application comprising:
a user-analysis component that examines at least one user action and content associated with the action with respect to at least one of the following computer-based applications comprising: outbound messaging system, real-time messaging system, game system, and calendaring system; and
an advertisement delivery component that determines at least one advertisement to present to a user based at least in part on at least one of the user action, the content associated therewith, demographic information, and geographic information.

2. The system of claim 1, the real-time messaging system comprises a chat system and an instant messaging system.

3. The system of claim 1, the user action comprises composition of an outbound message.

4. The system of claim 3, the user-analysis component analyzes at least a portion of the content of the outbound message.

5. The system of claim 3, the advertisement delivery component appends at least one advertisement to the outbound message.

6. The system of claim 1, the user-analysis component examines user information, the information comprising at least one of demographic and geographic information combined with the content associated with the user action.

7. The system of claim 1, the user action comprises any one of the following with respect to the calendaring system: composition of a calendar entry, composition of an invitation, and acceptance of the invitation; and the content associated with the action comprises text content, image content, time, date, and day of at least one of the calendar entry and the invitation.

8. The system of claim 1, with respect to the real-time messaging system, the user action is performed by at least a first party and a second party to a real-time computer-based conversation.

9. The system of claim 1, the user-analysis component examines a history of user actions and the content associated therewith to facilitate determining the at least one advertisement to delivery to the user.

10. The system of claim 1, further comprising an advertisement share component that informs at least a second user related to a first user of an advertisement responded to by the first user.

11. A system that facilitates user privacy comprising:
a receiving component that receives user-related information, whereby the information comprises a user selection in connection with choosing an advertisement delivery preference for at least one messaging service employed by a user, and the advertisement delivery preference comprises receipt of one of content-targeted advertisements and non-content targeted advertisements; and
an advertising delivery component that delivers any one of content or non-content targeted advertisements to a user based at least upon the user selection, the user selection comprising at least one of a selection for non-content targeted advertisements or a selection for content-targeted advertisements, whereby the selection for the non-contented targeted advertisements results in a reduced user experience and the selection for content-targeted advertisements results in an improved user experience with respect to the at least one messaging service.

12. The system of claim 11, the reduced-user experience comprises at least one of the following: lower storage capacity on a messaging system; lower size limitations on a messaging system; and an increased receipt of non-content targeted advertisements.

13. The system of claim 11, the at least one messaging service comprising a chat messaging system and an instant messaging system.

14. The system of claim 11, further comprising a notification component that informs the user of at least one reason the user is targeted for at least one advertisement that is delivered to the user.

15. The system of claim 14, wherein the user is informed of the at least one reason in at least one of the following manners: the at least one reason is provided as part of the advertisement, the at least one reason is provided to the user when the user hovers over the advertisement, or the at least one reason is provided to the user when the user clicks on the advertisement.

16. A method that facilitates content-targeted advertising comprising:
analyzing at least one user action and content associated with the action with respect to at least one of the following computer-based applications comprising: outbound messaging system, real-time messaging system, game system, and calendaring system; and
determining at least one advertisement to present to a user based at least in part on the user action and the content associated therewith.

17. The method of claim 16, the user action comprises at least one of the following: at least one of preparing and sending an outbound message, playing an electronic game, at least one of composing or sending a calendar entry, at least one of composing or sending an invitation, and responding to the invitation; and the content associated with the user action comprises content of the outbound message, user profile information, recipient domain, history of outbound messages, name of environment in which the outbound message is communicated, and/or time, date, and/or day of at any one of the calendar entry and invitation.

18. The method of claim 16, further comprising notifying the user of content-targeted advertisements clicked on by others exhibiting a similar state as the user.

19. The method of claim 16, further comprising improving user privacy at least in part by informing the user of at least one reason for targeting the user with a particular content-targeted advertisement.

20. The method of claim 16, further comprising at least one of presenting the user with at least one content-targeted advertising and appending the at least one content-targeted advertisement to a corresponding outbound message.
